(19) United States
(12) Patent Application Publication
(10) Pub. No.: US 2025/0325140 A1
(43) Pub. Date: Oct. 23, 2025

(54) COOKING APPLIANCE

(71) Applicants: Tsann Kuen (Zhangzhou) Enterprise Co., Ltd., Zhangzhou (CN); StoreBound LLC, New York, NY (US)

(72) Inventors: Chunyu WU, Xiamen (CN); Hanxin QIU, Zhangzhou (CN); Ching Feng HUANG, Tainan (TW)

(73) Assignees: Tsann Kuen (Zhangzhou) Enterprise Co., Ltd, Zhangzhou (CN); StoreBound LLC, New York, NY (US)

(21) Appl. No.: 18/666,364

(22) Filed: May 16, 2024

(30) Foreign Application Priority Data
Apr. 19, 2024 (CN) 202410480623.7

(51) Int. Cl. A47J 37/06

(52) U.S. Cl. CPC A47J 37/0611

(57) ABSTRACT

A cooking appliance and a cooking appliance kit. The cooking appliance may include a housing having a base portion and a cover portion that is alterable between an open state and a closed state. The base portion may define a base cavity, and a first heating element may be located within the base cavity. A plate assembly may include a support plate having at least one opening and a cooking plate that is detachably coupled to the support plate within the at least one opening. The support plate may be detachably coupled to the base portion of the housing. The housing may include a locking mechanism for detachably locking the support plate to the housing. The support plate may include a locking mechanism for detachably locking the cooking plate to the support plate.

### CROSS-REFERENCE TO RELATED APPLICATIONS

The present application claims the benefit of priority to Chinese Patent Application No. 202410480623.7, filed Apr. 19, 2024, the entirety of which is incorporated herein by reference.

### BACKGROUND OF THE INVENTION

Professional and home chefs alike continually struggle with reducing countertop clutter and maintaining an aesthetically pleasing kitchen while striving to preserve the functionality of the kitchen. Electric appliances have been in use for some time, which allow a user to store the appliance in a cabinet when not in use, thereby freeing up countertop space. Depending on what food product is being cooked in the appliance, the cooking process may create a mess that is difficult to clean up. That mess may include food product spilling on the exterior and interior surfaces of the cooking appliance, as well as onto the countertop. Thus, a need exists for a cooking appliance of the type described herein that is easy to clean and reduces or eliminates mess on the countertop surface on which the appliance is located during cooking.

### BRIEF SUMMARY OF THE INVENTION

A cooking appliance and a cooking appliance kit. The cooking appliance may include a housing having a base portion and a cover portion. The cover portion may be alterable between an open state and a closed state. The base portion may define a base cavity, and a first heating element may be located within the base cavity. A plate assembly may include a support plate having at least one opening and a cooking plate that is detachably coupled to the support plate within the at least one opening. The support plate may be detachably coupled to the base portion of the housing. The housing may include a locking mechanism for locking the support plate to the housing. The support plate may include a locking mechanism for locking the cooking plate to the support plate. The locking mechanisms may be alterable to unlocked states so that the support plate can be detached from the housing and the cooking plate can be detached from the support plate.

In one aspect, the invention may be a cooking appliance comprising: a housing comprising a base portion defining a base cavity and a cover portion that is alterable relative to the base portion between an open state and a closed state; a first heating element located within the base cavity of the base portion of the housing; a plate assembly detachably coupled to the base portion of the housing to close an open top end of the base cavity, the plate assembly comprising: a support plate comprising a top surface, a bottom surface, and at least one opening extending from the top surface to the bottom surface; and at least one cooking plate detachably coupled to the support plate within the at least one opening of the support plate; and wherein the support plate of the plate assembly is detachably coupled to the base portion of the housing.

In another aspect, the invention may be a cooking appliance comprising: a housing comprising a first locking mechanism; at least one heating element located within the housing; a plate assembly comprising: a support plate comprising a top surface, a bottom surface, at least one opening extending from the top surface to the bottom surface, a first engagement feature, and a second locking mechanism; and at least one cooking plate comprising a second engagement feature; and wherein the support plate is configured to be locked to the housing via engagement between the first locking mechanism of the housing and the first engagement feature of the support plate, the first locking mechanism being alterable into an unlocked state to allow the support plate to be detached from the housing; and wherein the at least one cooking plate is configured to be locked to the support plate within the at least one opening via engagement between the second locking mechanism of the support plate and the second engagement feature of the at least one cooking plate, the second locking mechanism being alterable into an unlocked state to allow the at least one cooking plate to be detached from the support plate.

In yet another aspect, the invention may be a cooking appliance kit comprising: a housing comprising: a base portion and a cover portion that is hingedly coupled to the base portion and alterable between an open state and a closed state, at least one of the base portion and the cover portion comprising a heating element; and a first locking mechanism that is alterable between a first locked state and a first unlocked state; a support plate configured to be detachably coupled to the housing, the support plate comprising: a top surface, a bottom surface, and at least one opening extending from the top surface to the bottom surface; a first engagement feature that is configured to be engaged by the first locking mechanism to lock the support plate to the housing; and a second locking mechanism that is alterable between a second locked state and a second unlocked state; a plurality of cooking plates, each of the plurality of cooking plates configured to be detachably coupled to the support plate within the at least one opening of the support plate, each of the plurality of cooking plates comprising a second engagement feature that is configured to be engaged by the second locking mechanism when the cooking plate is positioned within the at least one opening to lock the cooking plate to the support plate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front perspective view of a cooking appliance in a closed state in accordance with an embodiment of the present invention;

FIG. 2 is a front perspective view of the cooking appliance of FIG. 1 in an open state;

FIG. 3 is an exploded top perspective view of the cooking appliance of FIG. 1;

FIG. 4 is an exploded bottom perspective view of the cooking appliance of FIG. 1;

FIG. 5 is a front perspective view of the cooking appliance of FIG. 1 in the open state with a plate assembly thereof removed from a housing thereof;

FIG. 6 is a front perspective view of the cooking appliance of FIG. 1 in the open state with the plate assembly removed from the housing and with cooking plates of the plate assembly removed from a support plate of the plate assembly;

FIG. 7A is a top perspective view of the support plate of the plate assembly;

FIG. 7B is a bottom perspective view of the support plate of the plate assembly;

FIG. 8A is a partial view of the cooking appliance of FIG. 1 illustrating an actuator of a first locking mechanism of the housing in a non-actuated state;

FIG. 8B is a cross-sectional view taken along line VIII-VIII of FIG. 2 with the actuator of the first locking mechanism in the non-actuated state;

FIG. 9A is the partial view of FIG. 8A with the actuator of the first locking mechanism in an actuated state;

FIG. 9B is the cross-sectional view of FIG. 8B with the actuator of the first locking mechanism in the actuated state;

FIG. 10 is the cross-sectional view of FIG. 8B, illustrating the plate assembly being detached from the housing;

FIG. 11 is a top perspective view of one of the cooking plates of the plate assembly;

FIG. 12 is a bottom perspective view of the cooking plate of FIG. 11;

FIG. 13A is a rear perspective view of the plate assembly;

FIG. 13B is a close-up view of area XIII of FIG. 13A with an arrow illustrating how to alter a second locking mechanism of the support plate from a locked state to an unlocked state to detach the cooking plate from the support plate;

FIG. 13C is a cross-sectional view taken along line XIIIC-XIIIC of FIG. 13B;

FIG. 13D is the close-up view of FIG. 13B with the second locking mechanism having been altered from the locked state to the unlocked state;

FIG. 14 is a view of a cooking appliance kit including a housing, a support plate, and a plurality of cooking plates in accordance with an embodiment of the present invention;

FIG. 15 is an exploded top perspective view of a cooking appliance in accordance with another embodiment of the present invention;

FIG. 16 is an exploded top perspective view of a cooking appliance in accordance with another embodiment of the present invention;

FIG. 17 is a rear perspective view of a plate assembly in accordance with an alternative embodiment of the present invention, the plate assembly including a support plate and two cooking plates;

FIG. 18 is a close-up view of area XVIII of FIG. 17 with a locking mechanism of the support plate in a locked state;

FIG. 19 is a cross-sectional view taken along line XIX of FIG. 19;

FIG. 20 is the close-up view of area XVIII of FIG. 17 with the locking mechanism of the support plate in an unlocked state; and

FIG. 21 is a cross-sectional view taken along line XXI of FIG. 20.

### DETAILED DESCRIPTION OF THE INVENTION

The following description of the preferred embodiment(s) is merely exemplary in nature and is in no way intended to limit the invention, its application, or uses. The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

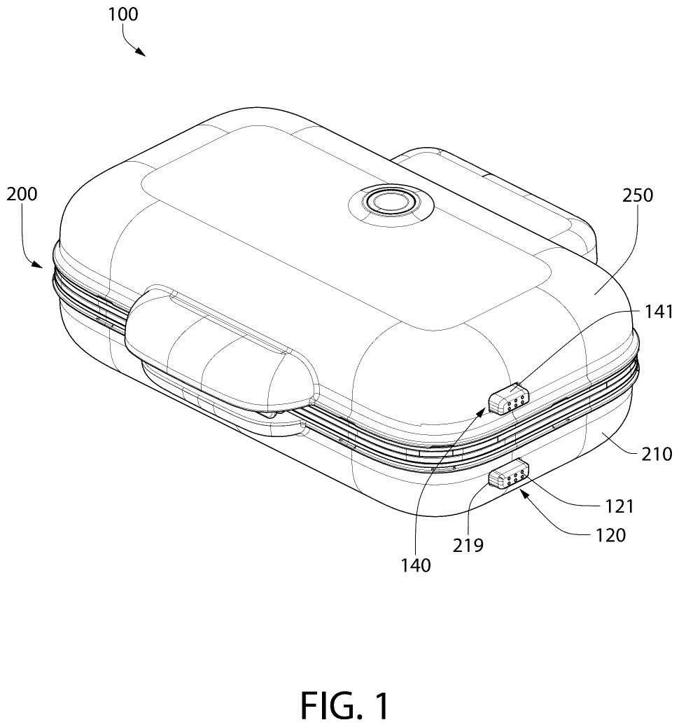

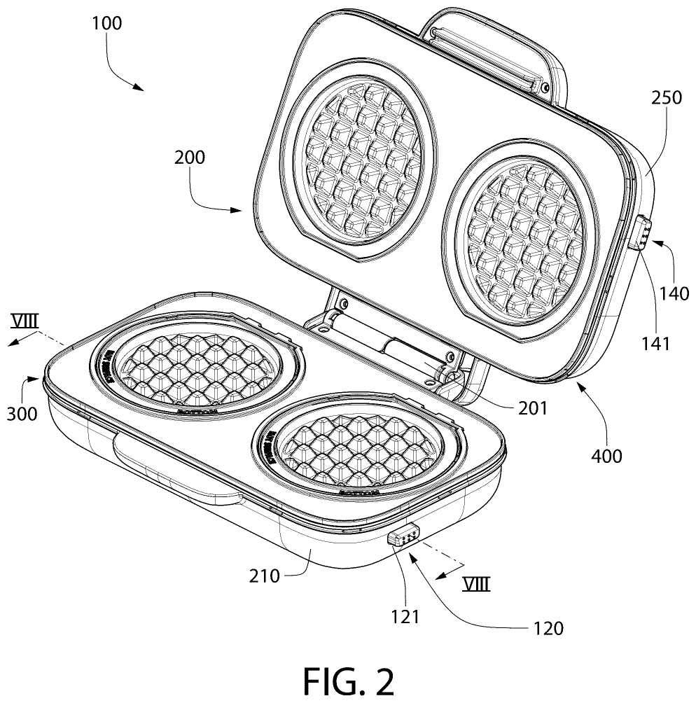

Referring to FIGS. 1 and 2, a cooking appliance 100 is illustrated in accordance with an embodiment of the present invention. The cooking appliance 100 comprises a housing 200, a first plate assembly 300, and a second plate assembly 400. The first plate assembly 300 may be detachably coupled to the housing 200. The second plate assembly 400 may also be detachably coupled to the housing 200. In alternative embodiments, the second plate assembly 400 may be fixedly attached to the housing 200 such that the second plate assembly 400 may not be readily detached from the housing 200 by the end-user, but may instead be fixed to the housing 200. As used herein, the term “detachably coupled” indicates that the cooking appliance 100 includes some functionality that facilitates ready detachment and separation of one component from another. Thus, the term detachably does not include any type of forcible detachment of two components which may result in damaging the cooking appliance 100, but rather refers to a built-in detachment capability that is purposeful.

The housing 200 of the cooking appliance 100 may comprise a base portion 210, a cover portion 250, and a hinge portion 201. The hinge portion 201 may be integrally connected with one of the base portion 210 and the cover portion 250. Alternatively, the hinge portion 201 may be separate from the base portion 210 and the cover portion 250 and may be coupled to both with fasteners or the like. The cover portion 250 may be alterable relative to the base portion 210 between an open state (FIG. 2) and a closed state (FIG. 1). In the exemplified embodiment, altering the cover portion 250 relative to the base portion 210 may comprise rotating the cover portion 250 about the hinge portion 201. In other embodiments, the hinge portion 201 may be omitted and the cover portion 250 may be unattached from the base portion 210. In such embodiments, the cover portion 250 may be wholly detached from the base portion 210 in the open state and attached to the base portion 210 in the closed state. The cooking appliance 100 may be loaded with an uncooked food product when in the open state and may be used to cook the food product when in the closed state. The cooking appliance 100 may be used to cook waffles or pancakes, although other food types may also be cooked in the cooking appliance 100. In some embodiments, the cooking appliance 100 may be capable of cooking food even when in the open state, similar to n electric stovetop.

In the exemplified embodiment, the first plate assembly 300 is detachably coupled to the base portion 210 of the housing 200. The housing 200 may comprise a first locking mechanism 120 to facilitate the locking attachment of the first plate assembly 300 to the base portion 210 of the housing 200. The first locking mechanism 120 may comprise a first actuator or button 121, and other features to be described below. A user may actuate the first button 121 to alter the first locking mechanism 120 from a locked state (or locked position) to an unlocked state (or unlocked position). The first locking mechanism 120 may be biased into the locked state, meaning it remains in the locked state unless altered into the unlocked state by the user actuating the first button 121, and returns to the locked state automatically upon the user releasing the first button 121.

In the exemplified embodiment, the second plate assembly 400 is detachably coupled to the cover portion 250 of the housing 200. The housing 200 may comprise a third locking mechanism 140 to facilitate the locking attachment of the second plate assembly 400 to the cover portion 250 of the housing 200. The second locking mechanism 140 may comprise a second actuator or button 141 and other features to be described below. A user may actuate the button 141 to alter the second locking mechanism 140 from a locked state (or locked position) to an unlocked state (or unlocked position). The second locking mechanism 140 may be biased into the locked state, meaning it remains in the locked state unless altered into the unlocked state by the user actuating the first button 121, and returns to the locked state automatically upon the user releasing the first button 121. In an alternative embodiment, the second plate assembly 400 may be fixedly coupled to the cover portion 250 of the housing 200. In such embodiments, the second locking mechanism 140 may be omitted.

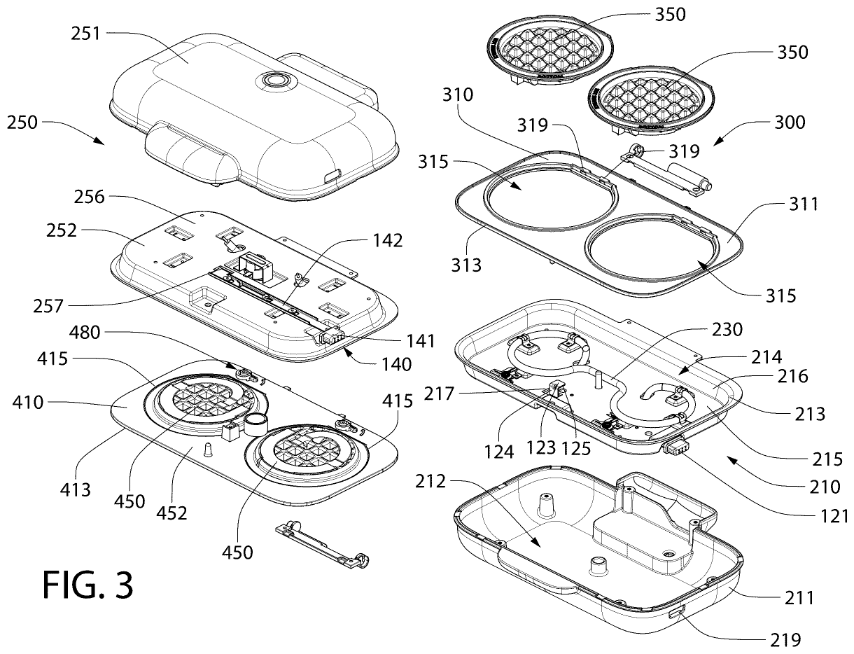

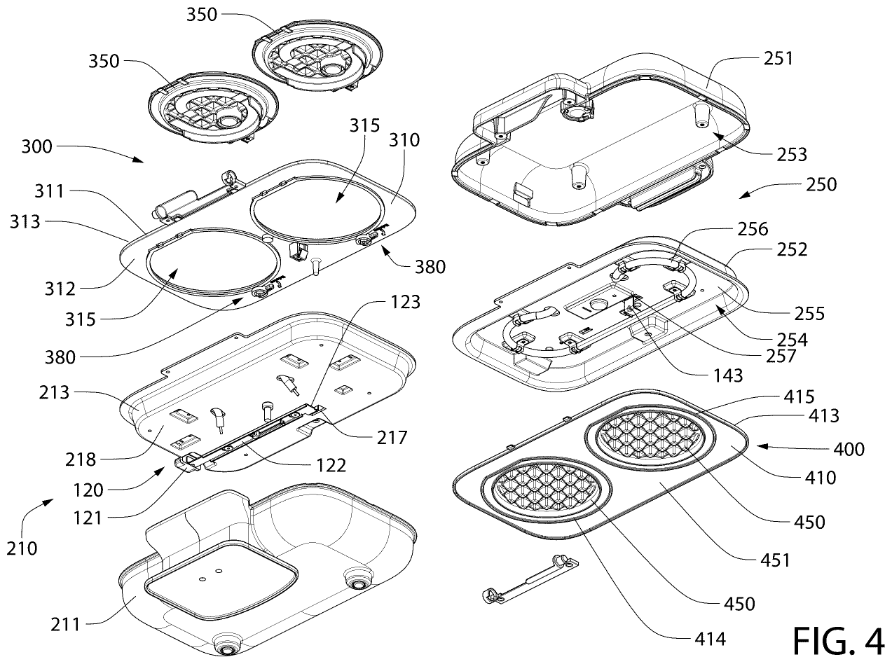

Referring to FIGS. 3 and 4, the components of the cooking appliance 100 will be described in more detail. As noted above, the housing 200 comprises the base portion 210 and the cover portion 250. The base portion 210 comprises a shell 211 that defines a shell cavity 212. An outer surface of the shell 211 forms an exterior of the base portion 210. The base portion 210 further comprises an insert 213 that is located within the shell cavity 212 of the shell 211. The insert 213 may be fixedly coupled to the shell 211 and may be located entirely within the shell cavity 212. The insert 213 may comprise a base cavity 214 that is defined by a floor 215 and a sidewall 216. The insert 213 may comprise an aperture 217 that extends from a rear surface 218 of the insert 213 to the floor 215 of the base cavity 214. The insert 213 may comprise multiple apertures that extend from the rear surface 218 to the floor 215 for connecting various electronic components to a power source. The aperture 217 may be associated with the first locking mechanism 120, as described further below.

The first locking mechanism 120 may comprise the first button 121, a first locking arm 122, and a first latch 123. The first locking arm 122 may be operably coupled to the first button 121 and to the first latch 123 and may extend between the first button 121 and the first latch 123. The first latch 123 may be located at a distal end of the first locking arm 122 that is furthest from the first button 121. When the housing 200 is fully assembled as shown in FIGS. 1 and 2, the first button 121 may extend through an opening 219 in a sidewall of the shell 211 so that the first button 121 is exposed and accessible for actuation along an exterior of the base portion 210 of the housing 200. The first locking arm 122 may extend along the rear surface 218 of the insert 213. The first locking arm 122 may be located within a channel in the rear surface 218 of the insert. Alternatively, the first locking arm 122 may be located alongside of the rear surface 218 without being located in a channel.

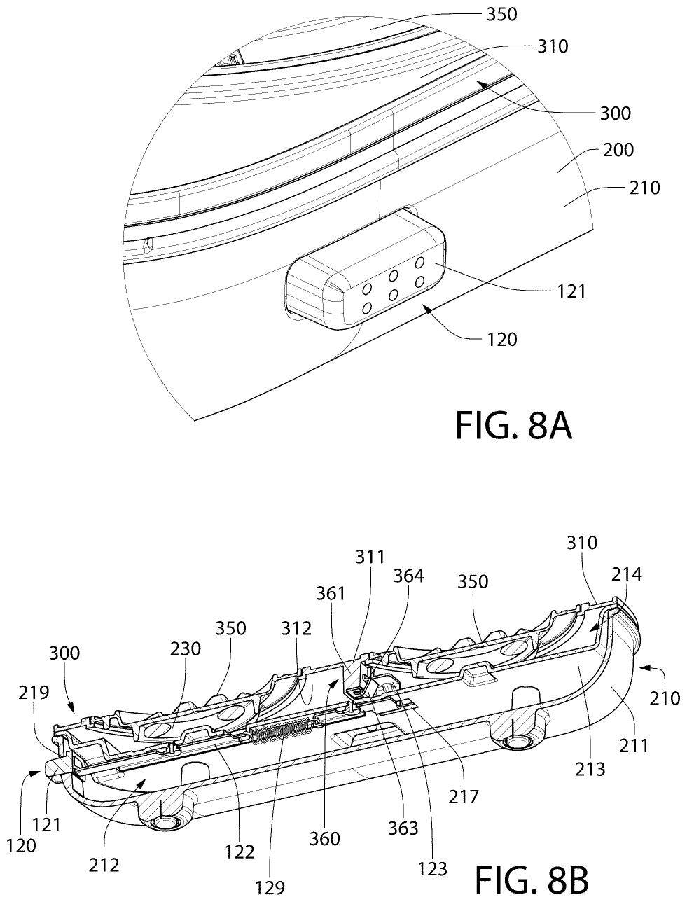

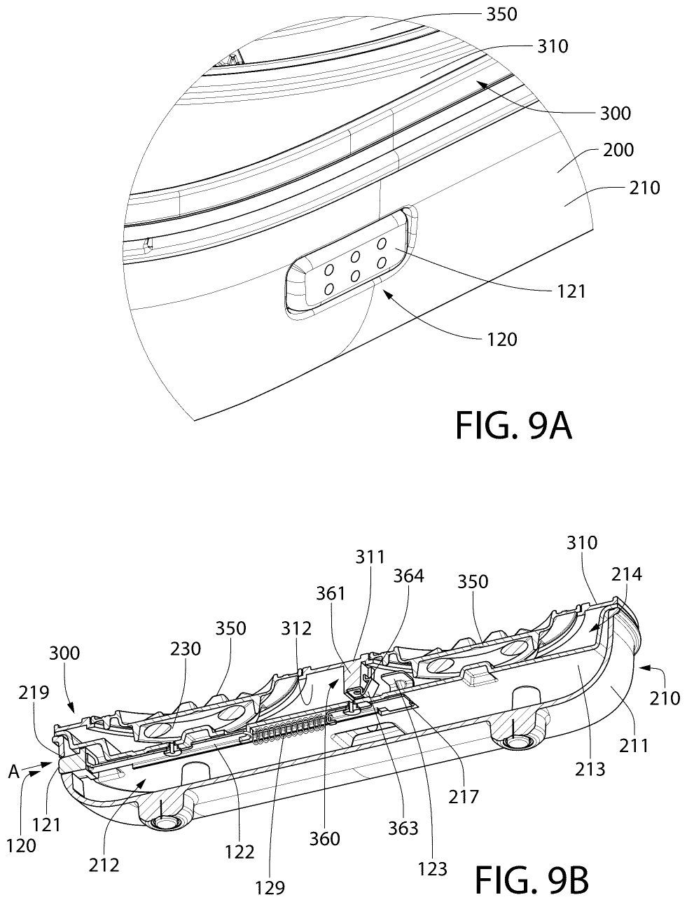

The first latch 123 may extend through the aperture 217 formed through the floor 215 of the base cavity 214 of the insert 213 so that the first latch 123 is positioned to come into engagement with an engagement feature of the first plate assembly 300 when the first plate assembly 300 is positioned within the base cavity 214, as described in greater detail below. The first latch 123 may comprise a vertical portion 124 and a horizontal portion 125 that extends horizontally from a distal end of the vertical portion 124. When a user actuates the first button 121, the first button 121, the first locking arm 122, and the first latch 123 may move in tandem in the direction that the first button 121 is pushed. The aperture 217 may have a greater length than the first latch 223 so that the first latch 123 is capable of moving within the aperture 217 when the first button 121 is actuated. The first locking mechanism 120 may be biased into the non-actuated (i.e., locked) state. Thus, upon a user releasing the first button 121, the first button, the first locking arm 122, and the first latch 123 may automatically return to their initial, at-rest position (i.e., the locked state). The first locking mechanism 120 may only be actuated into the unlocked state during such times that the button 121 is depressed. The first locking mechanism 120 may include a spring or other biasing device to bias the first locking mechanism 120 into the locked state as described (see, for example, FIGS. 8B and 9B).

A first heating element 230 may be located within the base cavity 214 of the insert 213 of the base portion 210 of the housing 200. The first heating element 230 may have any configuration and shape, including but not limited to the dual-loop and connector shape depicted in FIG. 3. The first heating element 230 may have end portions that extend through openings in the floor 215 of the base cavity 214 so that wiring can connect the first heating element 230 to a power source. The first heating element 230 may generate heat when activated. The cooking appliance 100 may include a plug (not shown) that is configured for engagement with a wall electrical socket. In some embodiments, the first heating element 230 may be activated automatically upon plugging the plug of the cooking appliance 100 into a wall electrical socket. In other embodiments, the cooking appliance 100 may also include a switch so that the user must activate the switch while the plug is plugged into a wall electrical socket to power the cooking appliance 100 so that the first heating element 230 generates heat for cooking.

The base cavity 214 may have an open top end. The first plate assembly 300 may be configured to be attached to the base portion 210 of the housing 200 to close the open top end of the base cavity 214. That is, the first plate assembly 300 may be configured to be detachably insertable into the base cavity 214 during which the first plate assembly 300 may be locked to the base portion 210 of the housing 200 by the first locking mechanism 120. Altering the first locking mechanism 120 from the locked state (into which it is biased) into the unlocked state may permit the first plate assembly 300 to be readily removed from the base cavity 214 and thereby detached from the base portion 210 of the housing 200.

The first plate assembly 300 may comprise a support plate 310 and at least one cooking plate 350. In the exemplified embodiment, the first plate assembly 300 comprises two of the cooking plates 350. In alternative embodiments, the first plate assembly 300 may comprise one of the cooking plates 350, or more than two of the cooking plates 350 such as three, or four, or five, or six, or seven, or eight of the cooking plates 350, for example. Each of the cooking plates 350 may be detachably coupled to the support plate 310, as described in greater detail herein below.

The support plate 310 may comprise a top surface 311, a bottom surface 312, and a peripheral edge 313 extending between the top and bottom surfaces 311, 312. The bottom surface 312 of the support plate 310 may face the floor 215 of the base cavity 214 when the first plate assembly 300 is located therein, and the top surface 311 of the support plate 310 may be exposed to the user when the housing 200 is in the open state. The support plate 310 may comprise at least one opening 315 that extends from the top surface 311 to the bottom surface 312. In the exemplified embodiment, the support plate 310 comprises two of the openings 315. In one alternative embodiment, the support plate 310 may comprise one of the openings 315. In other embodiments, the support plate 310 may comprise more than two of the openings 315, such as three, four, five, six, seven, or eight of the openings 315. Each of the openings 315 may be spaced inwardly from the peripheral edge 313. Thus, each of the openings 315 may be surrounded by portions of the top and bottom surfaces 311, 312 of the support plate 310. Each of the openings 315 may be a closed-geometric shape. In the exemplified embodiment, each of the openings 315 is circular, but they may have any other shape as may be desired, such as square, triangular, hexagonal, octagonal, irregular, etc.

In the exemplified embodiment, each of the openings 315 is a through-hole that extends through the full thickness of the support plate 310 from the top surface 311 to the bottom surface 312. In other embodiments, the openings 315 may be recesses with a floor (i.e., a blind hole rather than a through-hole). The through-hole embodiment may be preferable to ensure direct contact between the cooking plates 350 and the heating element 230 for optimized heating and cooking of food products during use.

In some embodiments, the number of the openings 315 may correspond to or match with the number of the cooking plates 350. This is because one of the cooking plates 350 is configured to be positioned within each of the openings 315 to form the assembled plate assembly 300. Each of the cooking plates 350 may be detachably coupled to the support plate 310 within one of the openings 315. For each of the openings 315, the support plate 310 may comprise a second locking mechanism 380 that engages with the cooking plate 350 that is located within the opening 315 to lock the cooking plate 350 to the support plate 310. The second locking mechanism 380 may be altered from a locked state to an unlocked state to allow the cooking plate 350 to be removed from the opening 315 and detached from the support plate 310. This may be desirable for cleaning, to exchange the cooking plate for another cooking plate with a different design or configuration, to replace a broken cooking plate, or for other reasons. Additional details about the second locking mechanism 380 and the process of locking/unlocking the cooking plates 350 to the support plate 310 will be provided below.

The cover portion 250 of the housing 200 may similarly comprise a shell 251 and an insert 252. The shell 251 may comprise a shell cavity 253 and the insert 252 may be located within the shell cavity 253. The insert 252 may be fixedly coupled to the shell 251. The insert 252 may define a cover cavity 254 having a floor 255. A second heating element 256 may be located within the cover cavity 254 of the insert 252. The second locking mechanism 140 may comprise the second button 141, a second locking arm 142 that extends along a rear surface 256 of the insert 252, and a second latch 143 that extends from a distal end of the second locking arm 142. The second latch 143 may extend through an aperture 257 formed into the floor 255 of the cover cavity 254. Operation of the second locking mechanism 140 may be the same as the first locking mechanism 120 described above. That is, pressing the second button 141 may cause the second button 141, the second locking arm 142, and the second latch 143 to move in one direction, and releasing the second button 141 may cause the second button 141, the second locking arm 142, and the second latch 143 to move in an opposite direction. The second locking mechanism 140 may be biased into the locked state such that it moves in the opposite direction automatically upon a user releasing the second button 141. A spring or other biasing element may be used to bias the second d locking mechanism 140 into the locked state. The second locking mechanism 140 may be used in embodiments whereby the second plate assembly 400 is detachably coupled to the cover portion 250. In an embodiment, the second plate assembly 400 may be fixed to the cover portion 250, and in such an embodiment the second locking mechanism 140 may be omitted.

The second plate assembly 400 may comprise a support plate 410 and at least one cooking plate 450. In the exemplified embodiment, the second plate assembly 400 comprises two of the cooking plates 450. In alternative embodiments, the second plate assembly 400 may comprise one of the cooking plates 450, or more than two of the cooking plates 450 such as three, or four, or five, or six, or seven, or eight of the cooking plates 450, for example. Each of the cooking plates 450 may be detachably coupled to the support plate 410, as described in greater detail herein below. There may be the same number of the cooking plates 450 as there are of the cooking plates 350. When the housing 200 is in the closed state, the cooking plates 350 and the cooking plates 450 may be aligned to define cooking cavities within which a food product (such as waffle or pancake batter, eggs, or the like) may be cooked.

The support plate 410 may comprise a top surface 411, a bottom surface 412, and a peripheral edge 413 extending between the top and bottom surfaces 411, 412. The bottom surface 412 of the support plate 410 may face the floor 255 of the cover cavity 254 when the second plate assembly 400 is located therein, and the top surface 411 of the support plate 410 may be exposed to the user when the housing 200 is in the open state. The support plate 410 may comprise at least one opening 415 that extends from the top surface 411 to the bottom surface 412. In the exemplified embodiment, the support plate 410 comprises two of the openings 415. In one alternative embodiment, the support plate 410 may comprise one of the openings 415. In other embodiments, the support plate 410 may comprise more than two of the openings 415, such as three, four, five, six, seven, or eight of the openings 415. Each of the openings 415 may be spaced inwardly from the peripheral edge 413. Thus, each of the openings 415 may be surrounded by portions of the top and bottom surfaces 411, 412 of the support plate 410. Each of the openings 415 may be a closed-geometric shape. In the exemplified embodiment, each of the openings 415 is circular, but they may have any other shape as may be desired.

In some embodiments, the number of the openings 415 may correspond to or match with the number of the cooking plates 450. This is because one of the cooking plates 450 is configured to be positioned within each of the openings 415 to form the assembled plate assembly 400. Each of the cooking plates 450 may be detachably coupled to the support plate 410 within one of the openings 415. For each of the openings 415, the support plate 410 may comprise a fourth locking mechanism 480 that engages with the cooking plate 450 that is located within the opening 415 to lock the cooking plate 450 to the support plate 410. The fourth locking mechanism 480 may be altered from a locked state to an unlocked state to allow the cooking plate 450 to be removed from the opening 415 and detached from the support plate 410. This may be desirable for cleaning, to exchange the cooking plate for another cooking plate with a different design or configuration, to replace a broken cooking plate, or for other reasons. The fourth locking mechanism 480 may be identical in structure and function to the second locking mechanism 380, and thus reliance on the discussion of the second locking mechanism 380 may be entirely applicable to the fourth locking mechanism 480. In some embodiments, the fourth locking mechanism 480 may be omitted and the cooking plates 450 may be fixedly coupled to the support plate 410.

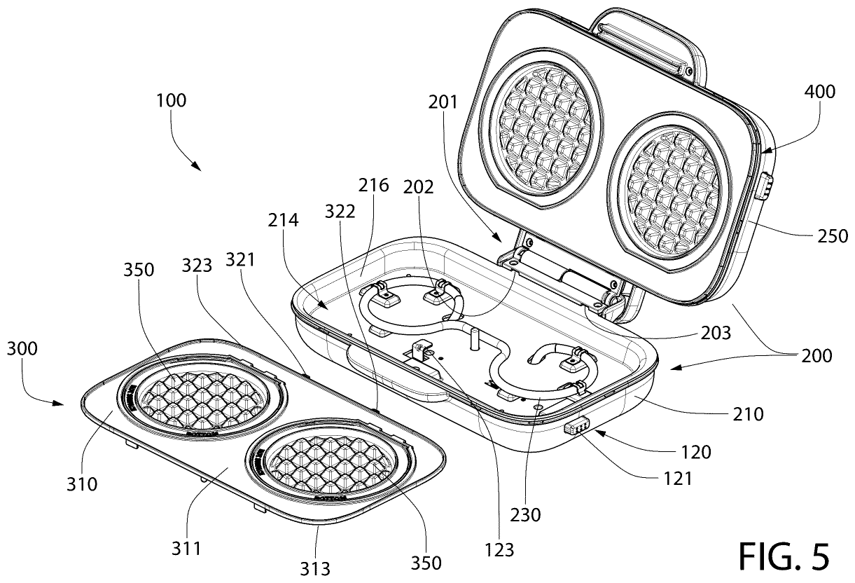

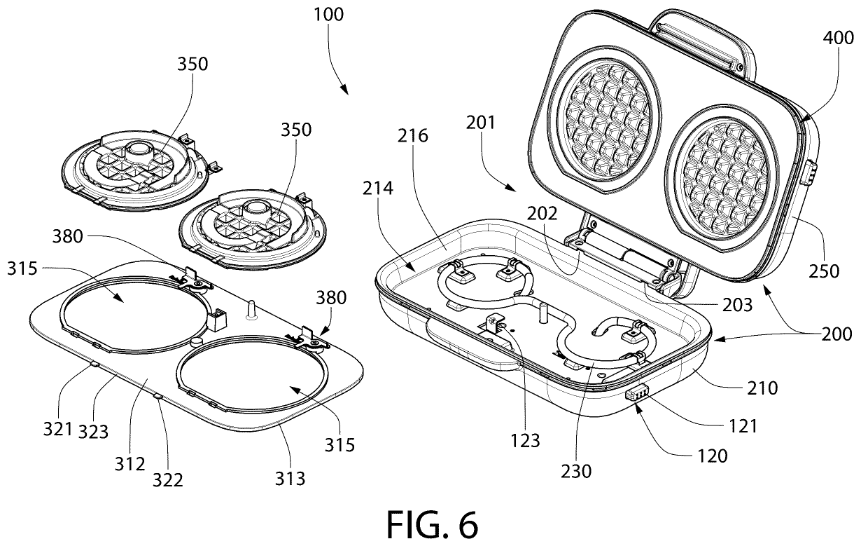

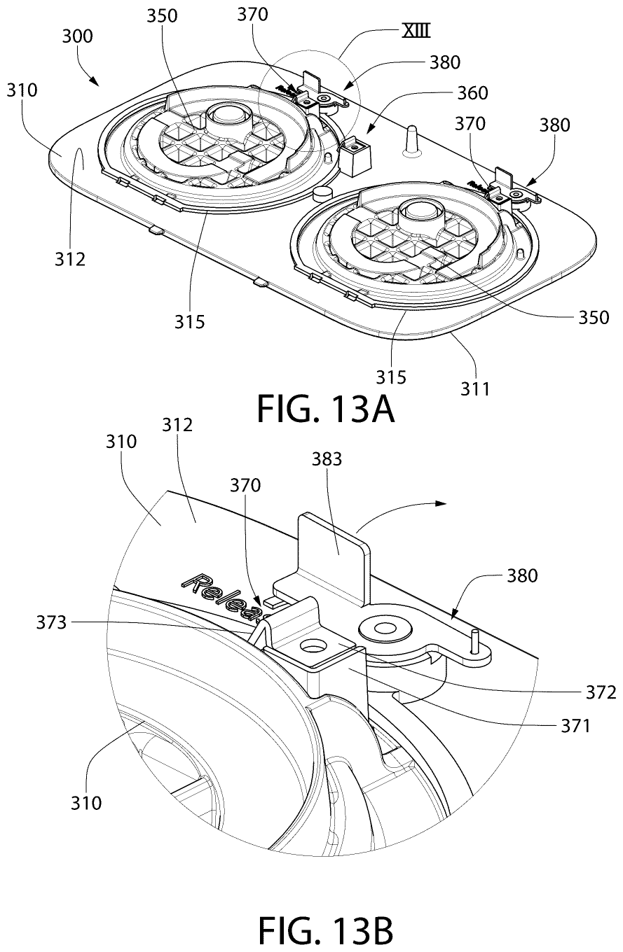

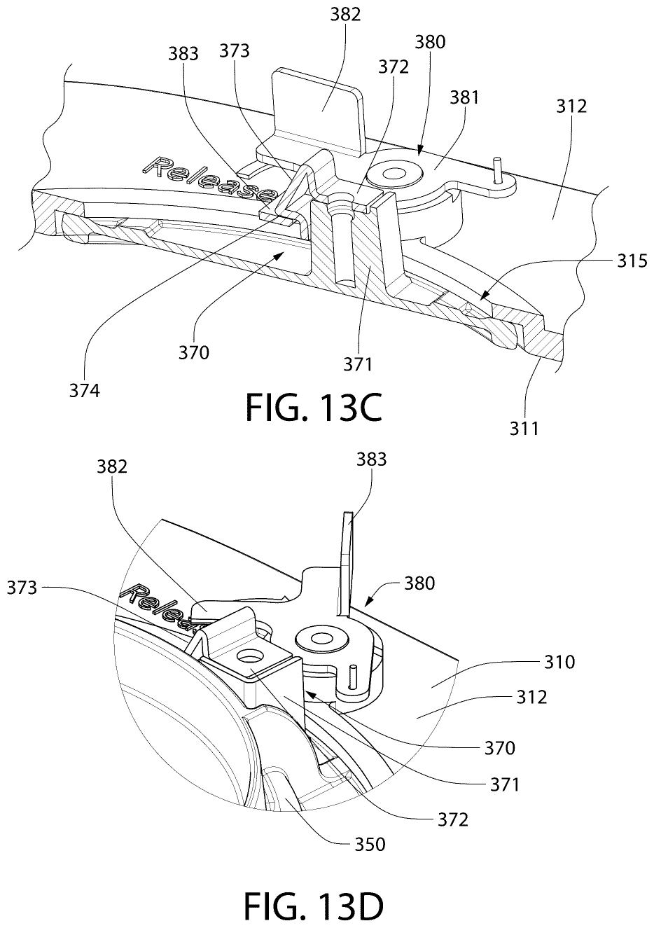

Referring to FIGS. 5 and 6, the cooking appliance 100 is illustrated with the cover portion 250 in the open state. Furthermore, the second plate assembly 400 remains coupled to the cover portion 250. As noted, the second plate assembly 400 may be fixed to the cover portion 250. Alternatively, the second plate assembly 400 may be detachable from the cover portion 250 as described. In FIGS. 5 and 6, the first plate assembly 300 is detached and separated from the base portion 210 of the housing 200. As such, the base cavity 214 and the first heating element 230 are visible and exposed. When the first plate assembly 300 is coupled to the base portion 210 (see FIG. 2), the first plate assembly 300 closes the open top end of the base cavity 214 so that the first heating element 230 is no longer exposed. In FIG. 5, the first plate assembly 300 is assembled, such that the cooking plates 350 are coupled to the support plate 310. In FIG. 6, the cooking plates 350 have been detached from the support plate 310. As described above, the cooking plates 350 may be detached from the support plate 310 by actuating the second locking mechanism 380. The details of this process will be provided below with reference to FIGS. 13A-13D.

As seen in FIGS. 5 and 6, the housing 200 comprises a first notch 202 and a second notch 203. In the exemplified embodiment, the first and second notches 202, 203 may be located along the hinge portion 201 of the housing 200. The first and second notches 202, 203 may alternatively be formed into the sidewall 216 of the base cavity 215. The support plate 310 of the plate assembly 300 may comprise a first tab 321 and a second tab 322 protruding from a rear portion 323 of the peripheral edge 313. When the support plate 310 is coupled to the housing 200, the first and second tabs 321, 322 may be received within the first and second notches 202, 203, respectively. This, along with the engagement of the first latch 123 of the first locking mechanism 120 with an engagement feature of the support plate 310, helps to lock the support plate 310 to the base portion 210 of the housing 200.

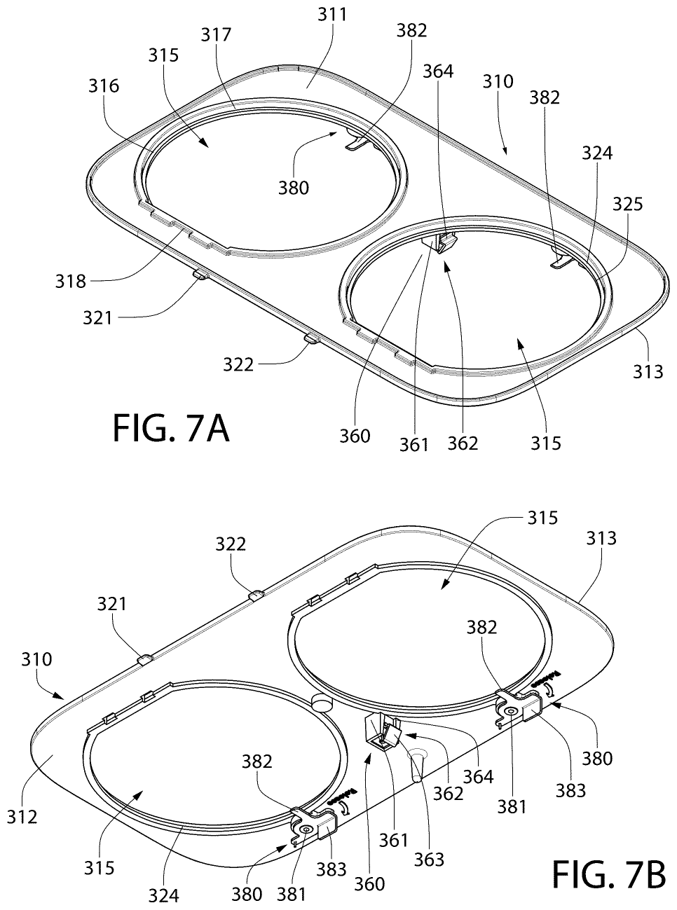

Referring now to FIGS. 7A and 7B, the support plate 310 of the first plate assembly 300 will be described. It should be appreciated that the support plate 410 of the second plate assembly 400 may be identical to the support plate 310 of the first plate assembly 300. Thus, in embodiments wherein the second plate assembly 400 is detachable from the housing 200 and the cooking plates 450 are detachable from the support plate 410, the description of the support plate 310 is entirely applicable to the support plate 410. As noted, the support plate 310 comprises the top surface 311, the bottom surface 312, the peripheral edge 313, and the one or more openings 315 extending from the top surface 311 to the bottom surface 312. The first and second notches 321, 322 are depicted in these figures. The support plate 310 further comprises a ledge 324 having a ledge surface 325 that is recessed relative to the top surface 311 of the support plate 310. The ledge surface 325 faces in the same direction as the top surface 311 of the support plate 310.

The support plate 310 comprises a first engagement feature 360 that is configured to be engaged by the first latch 123 of the first locking mechanism 120 when the support plate 310 is located within be base cavity 214 of the base portion 210 of the housing 200. The first engagement feature 360 may comprise a post 361 protruding from the bottom surface 312 of the support plate 310 and a first engagement bracket 362 coupled to the post 361. In other embodiments, the first engagement feature 360 may comprise the first engagement bracket 362 only, but not also the post 361. The first engagement bracket 362 may comprise an angled engagement surface 363 and a planar locking surface 364. The angled engagement surface 363 may be located further from the bottom surface 312 of the support plate 310 than the planar locking surface 364. The planar locking surface 364 may be oriented generally parallel to the bottom surface 312 of the support plate 310 and the angled engagement surface 363 may be oriented at an oblique angle (e.g., acute angle) relative to the planar locking surface 364. The configuration of the first engagement feature 360 may facilitate automatically locking the support plate 310 to the base portion 210 of the housing 200 when the support plate 310 is inserted into the base cavity 214, as described in more detail below.

The support plate 310 may also comprise, for each of the openings 315, one of the second locking mechanisms 380. In the exemplified embodiment, the support plate 300 comprises two of the openings 315, each configured to receive one of the cooking plates 350. Thus, in the exemplified embodiment the support plate 300 comprises two of the second locking mechanisms 380, each configured to lock one of the cooking plates 350 to the support plate 300 within one of the openings 315. Each of the second locking mechanisms 380 is located adjacent to one of the openings 315 in the support plate 310.

Each of the second locking mechanisms 380 comprises a base plate 381, a second latch 382, and a second actuator 383. In an embodiment, the base plate 381 may comprise a top surface and a bottom surface, and the second actuator 383 may comprise a tab protruding from the top surface. The second latch 382 may comprise an arm that protrudes radially from the base plate 381 towards the opening 315. When in the locked state as shown in FIG. 7B, the second latch or arm 382 may overlap with a portion of the opening 315 with which it is associated. The second locking mechanism 380 may be altered from the locked state to an unlocked state by rotating the base plate 381, including the second latch 382 and the second actuator 383, about a rotational axis. That is, a user may grip the second actuator 383 and rotate the second actuator 383 in the direction of the arrow shown on the bottom surface 312 of the support plate 310 in FIG. 7B. This will rotate the second latch 382 out of alignment with the opening 315 to permit one of the cooking plates 350 to be inserted into or removed from the opening 315.

The second locking mechanism 380 may comprise a biasing element, such as a spring, more specifically a torsion spring, that biases the second locking mechanism 380 into the locked state. Thus, the second locking mechanism 380 may only be altered from the locked state to the unlocked state when a rotational force is applied onto the second locking mechanism 380. The second locking mechanism may automatically return to the locked state upon the cessation of the rotational force (i.e., when the user releases the second locking mechanism). Alternatively, the user may have to apply a force to alter the second locking mechanism from the locked state to the unlocked state and may have to apply a reverse force to alter the second locking mechanism from the unlocked state to the locked state.

In the exemplified embodiment, the second locking mechanism 380 is located on the bottom surface 312 of the support plate 310. As such, the second locking mechanism 380 is not accessible to the user when the support plate 310 is coupled to the housing 200 because the bottom surface 312 is located within the base cavity 214 and is not exposed to the user. Thus, in accordance with the exemplified embodiment, a user may need to first detach the support plate 310 form the housing 300 prior to detaching the cooking plates 350 from the support plate 310. However, the cooking plates 350 may be able to be attached to the support plate 310 without removing the support plate 310 from the housing 200 because the cooking plates 350 are coupled to the support plate 310 by inserting them into the opening 315 via the top surface 311, as better understood from the discussion of FIGS. 13A-13D below.

Each of the openings 315 in the support plate 310 may be defined by an annular sidewall 316. The annular sidewall 316 may comprise an arcuate front portion 317 and a planar rear portion 318. Furthermore, the annular sidewall 316 may comprise at least one notch 319 (seen in FIG. 3) in the planar rear portion 318 of the annular sidewall 316. In the exemplified embodiment, there are a pair of notches 319 located in the annular sidewall 316. These notches 319 are configured to receive tabs on the cooking plates 350 to facilitate the attachment of the cooking plates 350 to the support plate 310.

Referring now to FIGS. 8A-9B, the process of detaching the support plate 310 (and more specifically the first plate assembly 300) from the housing 200 (and more specifically the base portion 210 of the housing 200) will be described. In embodiments wherein the second plate assembly 400 is detachable from the housing 200, the description of the process of detaching the first plate assembly 300 from the housing 200 is applicable. That is, the structure and function for detaching the first and second plate assemblies 300, 400 from the housing 200 is the same. However, in some embodiments the second plate assembly 400 may be fixed to the housing 200.

FIGS. 8A and 8B illustrate the cooking appliance 100 with the plate assembly 300 located within the base cavity 214 of the base portion 210 of the housing 200 and with the first locking mechanism 120 in the locked state. The plate assembly 300 closes the open top end of the base cavity 214. When the plate assembly 300 is located in the base cavity 214 as shown and the button 121 of the first locking mechanism 120 is not being actuated, the first latch 123 of the first locking mechanism 120 engages the first engagement feature 360 of the support plate 310 to lock the support plate 310 to the base portion 210 of the housing 200. More specifically, the first latch 123 of the first locking mechanism 120 engages or contacts the planar locking surface 364 of the first engagement feature 360. The first latch 123 may be located between the planar locking surface 364 of the first engagement feature 360 and the bottom surface 311 of the support plate 310, which prevents the support plate 310 from being removed from the base cavity 213. That is, attempting to remove the support plate 310 from the base cavity 214 while the first locking mechanism 120 is in the locked state will result in the planar locking surface 364 of the first engagement feature 360 contacting the first latch 123, which prevents the removal of the support plate 310.

A biasing device, such as a spring, may be included to bias the first locking mechanism 120 into the locked state shown in FIG. 8B. Thus, in its natural or at-rest state, the first locking mechanism 120 may be biased into the locked state. A user may need to actuate the first button 121 to alter the first locking mechanism 120 from the locked state to the unlocked state. Upon a user releasing the first button 121 and no longer actuating the first button 121, the first locking mechanism 120 may be automatically biased back to the locked state. A spring or other biasing device may be used to achieve this biasing of the first locking mechanism 120 into the locked state. FIG. 8B illustrates a tension spring 129 that is used to bias the first locking mechanism 120 into the locked state, but other components or features may be used in other embodiments, including other types of spring such as compression springs, torsion springs, and spiral springs, or other non-spring type biasing devices.

As shown in FIG. 8B, when the plate assembly 300 is located within the base cavity 214 of the base portion 210 of the housing 200, the first heating element 230 nests within a recess in a lower surface of the cooking plates 350. The first heating element 230 may be in contact with the lower surface of the cooking plates 350. Thus, heat generated by the first heating element 230 may be transmitted conductively to the cooking plates 350, which may in turn heat and cook food placed on an upper surface thereof. The cooking plates 350 may be formed from a heat conductive metal material, such as copper, aluminum, iron, or the like, to allow the heat generated by the first heating element 230 to be transmitted conductively to the cooking plates 350. Furthermore, there may be wiring, a power source, a processor/controller, or other electronic components located within he shell cavity 212 between the bottom surface insert 213 and the floor of the shell 211. For example, wiring may be connected to a plug and to the first heating element 230 to activate the first heating element 230 when the plug is plugged into a wall socket.

Turning to FIGS. 9A and 9B, illustrations identical to FIGS. 8A and 8B, respectively, are provided, except that the first button 121 is being actuated in FIGS. 9A and 9B so that the first locking mechanism 120 has been altered from the locked state of FIGS. 8A and 8B to an unlocked state. Specifically, by pressing the first button 121 in a first axial direction A, the first button 121, the first locking arm 122, and the first latch 123 move in the first axial direction A. As seen from a comparison of FIG. 9B with FIG. 8B, actuating the first button 121 causes the first latch 123 to move within the aperture 217 and disengage from the first engagement feature 360 of the support plate 310. Specifically, the first latch 123 moves away from the planar engagement surface 364 of the first engagement feature 360 so that the latch 123 is no longer located between the planar engagement surface 364 and the bottom surface 312 of the support plate 311. If the user were to release the first button 121, the torsion spring 129 would cause the first button 121, along with the first locking arm 122 and the first latch 123, to retract by moving in a second axial direction that is opposite the first axial direction A. Thus, in some embodiments the user may remove the plate assembly 300 from the housing 200 while actuating the first button 121.

In an alternate embodiment, upon the user actuating the first button 121, the first latch 123 will move as shown and the first plate assembly 300 will slightly pop upwardly out of the base cavity 214. As a result, when the user releases the first button 121, the first latch 123 will contact the angled engagement surface 363 rather than the planar locking surface 364. As the first latch 123 contacts the angled engagement surface 363 as it is moving in the second axial direction that is opposite to the direction A, this may further elevate the first plate assembly 300 out of the base cavity 214. This will allow the user to separate the first plate assembly 300 from the housing 200 without having to continually press the first button 121.

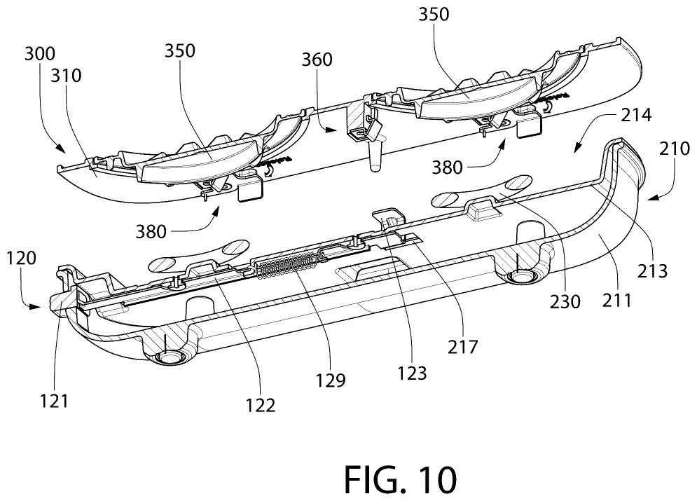

As shown in FIG. 10, once the first locking mechanism 120 has been altered from the locked state (FIGS. 8A and 8B) to the unlocked state (FIGS. 9A and 9B), the first plate assembly 300 may be removed from the base cavity 214 of the housing 200. The first plate assembly 300 may remain assembled with the cooking plates 350 coupled to the support plate 310 as the first plate assembly 300 is separated from the housing 200.

To couple the first plate assembly 300 to the housing 200, the user inserts the tabs 322 of the support plate 310 into the notches 202 of the housing 200 and then pivots the first plate assembly 300 downwardly. As the user pivots the first plate assembly 300 downwardly, the angled engagement surface 363 of the first engagement feature 360 engages the first latch 123 of the first locking mechanism 120. The first latch 123 moves in a direction of the arrow A (towards the unlocked state/position) as the first latch 123 rides along the angled engagement surface 363 of the first engagement feature 360. That is, the first latch 123 first engages a lower section of the angled engagement surface 363 that is furthest from the planar locking surface 364 and rides along the angled engagement surface 363 until it is located at the top section of the angled engagement surface 363 that is adjacent to the planar locking surface 364. Upon the first latch 123 passing by the end of the angled engagement surface 363, the first latch 123 snaps back to the locked state/position over top of and in engagement with the planar locking surface 354 of the first engagement feature 360. Thus, the user may not need to press the first button 121 during the process of coupling the first plate assembly 300 to the base portion 210 of the housing 200. Rather, the locking attachment may occur automatically in the process of inserting the first plate assembly 300 into the base cavity 214.

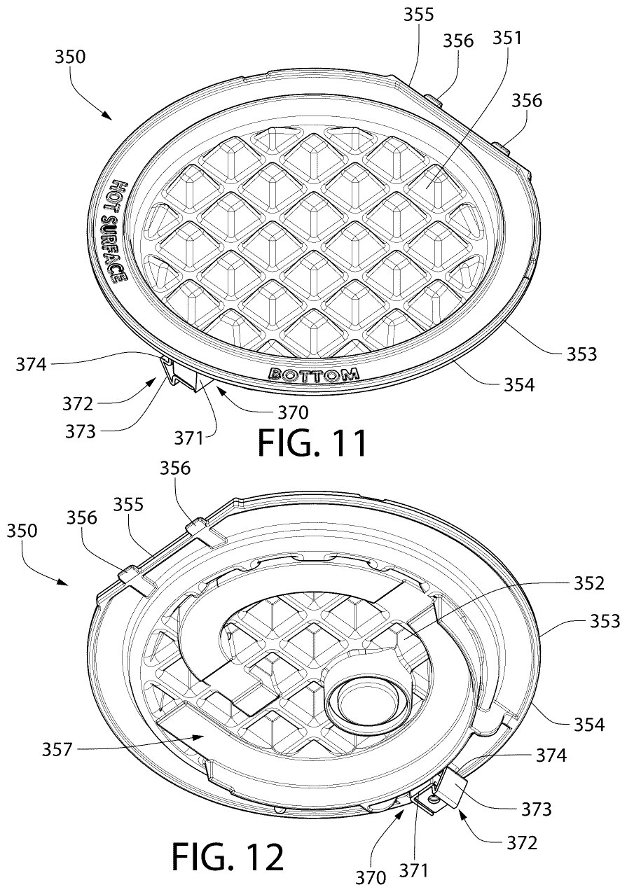

Referring to FIGS. 11 and 12, one of the cooking plates 350 is illustrated and will be described. The cooking plate 350 comprises a cooking surface (a top surface) 351 and a non-cooking surface (a bottom surface) 352. The cooking plates 350 may all be identical to the cooking plate 350 shown in FIGS. 11 and 12. Alternatively, there may be different cooking plates with different designs on their cooking surfaces 351 to create waffles/pancakes or other food items with different designs. In the embodiment where two of the cooking plates 350 are attached to the support plate 310 to form the first plate assembly 300, there may be two identical cooking plates 350, two cooking plates with different designs on their cooking surfaces 351, or the like. In the exemplified embodiment, the cooking surface 351 has a waffle pattern with a plurality of truncated pyramid shapes, although other shapes may be used as desired.

The cooking plate 350 comprises a peripheral edge 353 located between the cooking and non-cooking surfaces 351, 352. The peripheral edge 353 may comprise an arcuate portion 354 and a planar portion 355, which may match with the shape of the annular sidewall 316 of the support plate 310 described above. Furthermore, the cooking plate 350 may comprise one or more (e.g., a pair of) tabs 356 protruding from the planar portion 355 of the peripheral edge 353. Each of the tabs 356 may be configured to be received in one of the notches 319 of the support plate 310 when the cooking plates 350 are coupled to the support plate 310.

The non-cooking surface 352 comprises a recess 357 for receiving a portion of the first heating element 230 as described above. Furthermore, the cooking plate 350 may comprise a second engagement feature 370 located on the non-cooking surface 352. The second engagement feature 370 is configured to be engaged by the second latch 382 of the second locking mechanism 380 of the support plate 310 to lock the cooking plate 350 to the support plate 310, as described further below. The second engagement feature 370 may comprise a post 371 protruding from the non-cooking surface 352 of the cooking plate 350 and an engagement bracket 372 coupled to the post 371. The engagement bracket 372 may comprise an angled engagement surface 373 and a planar locking surface 374. The angled engagement surface 373 may be located further from the non-cooking surface 352 than the planar locking surface 354. The angled engagement surface 373 may extend from the planar locking surface 374 at an oblique angle (e.g., an acute angle). The planar locking surface 354 may be spaced apart from the non-cooking surface 352 by a gap so that the second latch 382 may nest within the gap when in the locked state. While the exemplified embodiment depicts the second engagement feature 370 as comprising the post 371 and the engagement bracket 372, in other embodiments the second engagement feature 370 may be a unitary/integral component.

Referring to FIGS. 13A-13D, the attachment and detachment of the cooking plates 350 to the support plate 300 will be described. FIGS. 13A-13C illustrate the cooking plates 350 located within the openings 315 of the support plate 310 and locked to the support plate 310 due to the engagement between the second latch 382 of the second locking mechanism 380 of the support plate 310 and the planar locking surface 354 of the second engagement feature 350 of the cooking plate 350. As noted previously, the second locking mechanism 380 may be biased into the locked state depicted in FIGS. 13A-13D. In an embodiment, the cooking plates 350 may be inserted into the openings 315 via/through the top surface 311 of the support plate 310. During this insertion of the cooking plates 350 into the openings 315, the angled engagement surface 373 of the second engagement feature 370 of the cooking plate 370 may contact the second latch 382 of the second locking mechanism 380 of the support plate 310 and cause the second latch 382 to pivot/rotate as it slides against the angled engagement surface 373 as the cooking plate 350 is moved further into the opening 315. Upon the second latch 382 passing the end of the second engagement surface 373, the second latch 382 may automatically snap back into the locked state whereby the second latch 382 extends over and in engagement/contact with the planar locking surface 374 of the second engagement feature 370. Thus, when the cooking plate 350 is fully seated within the opening 315 of the support plate 310, the cooking plate 350 may be locked to the support plate 310 due to the engagement between the second latch 382 of the second locking mechanism 380 and the planar locking surface 374 of the second engagement feature 370. As used herein and in the context of the second latch 382 and the planar locking surface 374, the term engagement may not require a physical contact between the second latch 382 and the planar locking surface 374. Rather, the term engagement may include other physical relationships between the second latch 382 and the planar locking surface 384 whereby the second latch 382 prevents the cooking plate from being detached from the support plate due to an interference created by the second latch 382. Thus, the term engagement may include direct physical contact, abutting contact, or a blocking or interference without physical contact. With the second latch 382 in this position, it should be appreciated that the cooking plate 350 cannot be removed from the opening 315.

Referring to FIG. 13D, the second locking mechanism 380 must be altered from the locked state to the unlocked state to allow for the cooking plate 350 to be removed from the opening 315 of the support plate 310. This may be achieved by the user gripping the second actuator 383 of the second locking mechanism 380 and rotating the second locking mechanism 380 in the direction of the arrow B (which is a clockwise direction in the exemplified embodiment). This rotation of the second locking mechanism 380 rotates the second latch 382 out of engagement with the planar locking surface 374 of the second engagement feature 370. Thus, once so rotated the second latch 382 no longer prevents removal of the cooking plate 350 from the opening 315. With the second latch 382 in the unlocked state/position shown in FIG. 13D, the cooking plate 350 may be removed from the opening 315 in the direction of the top surface 311 of the support plate 310, indicated with the arrow C. As noted, in some embodiments the second locking mechanism 380 may include a spring, such as a torsion spring, to bias the second locking mechanism 380 into the locked state. In such embodiments, once the cooking plate 350 is removed and the user releases the second actuator 383, the second locking mechanism 380 may return to the locked state. As noted above, the user may not need to alter the second locking mechanism 380 into the unlocked state before replacing the cooking plate 350 (or another cooking plate) within the opening. Rather, this may occur automatically due to the engagement between the second latch 382 and the angled engagement surface 373 during the insertion of the cooking plate 350 into the opening 315.

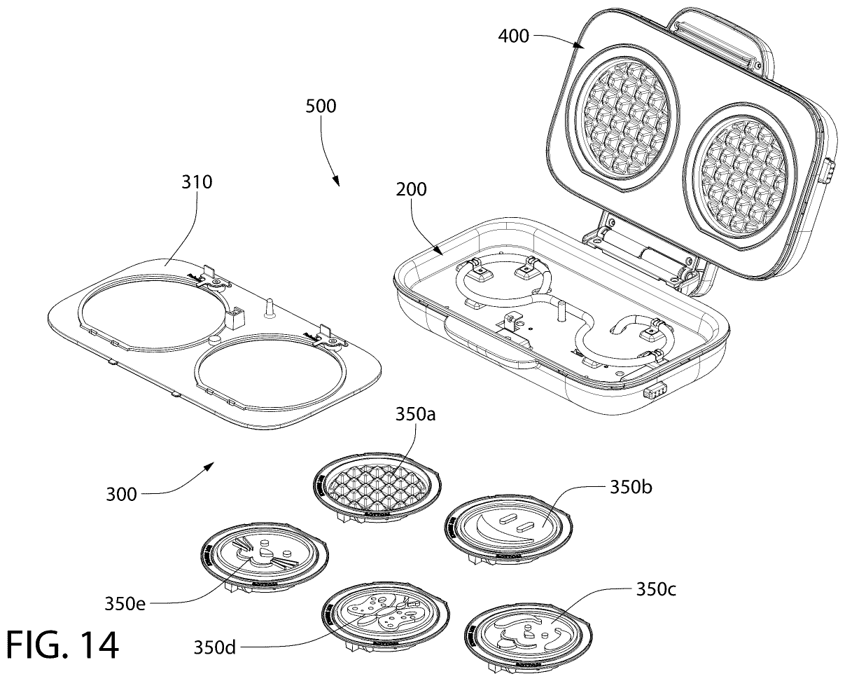

Referring to FIG. 14, a cooking appliance kit 500 is illustrated in accordance with an embodiment of the present invention. The cooking appliance kit 500 comprises the housing 200, the first plate assembly 300 comprising the support plate 310 and a plurality of the cooking plates 350a-e, and the second plate assembly 400. The cooking plates 350a-e may each comprise a different design on its cooking surface. For example, the cooking plate 350a comprises pyramid-shaped protrusions to form a conventional shaped waffle, the cooking plate 350b comprises a smiley face design, the cooking plate 350c comprises a dog-face design, the cooking plate 350d comprises a butterfly design, and the cooking plate 350e comprises a cat-face design. Other designs may be used as desired. Thus, in the cooking appliance kit 500, the user may select which of the cooking plates 350a-e to couple to the support plate 310 to form the first plate assembly 300 that is then coupled to the housing 200 to form cooked food products.

When the cooking appliance 100 described herein is used to cook food, typically the food is introduced onto the cooking plates 350 in a liquid form and is hardened during the cooking process. For example, batter used for forming pancakes or waffles, or eggs, may be fluidic prior to being heated and cooked. There may be occasions where the fluidic food product may spill out of the cavity defined between the upper and lower cooking plates either before or during the cooking process. By including the support plate 310 and the cooking plates 350, any excess food material may end up located on the support plate 310, rather on the exterior of the housing 200. Because the support plate 310 and the cooking plates 350 are removable from the housing 200, the support plate 310 and the cooking plates 350 can be easily cleaned between uses. Furthermore, by including the support plate 310 with multiple openings for receiving the cooking plates 350, more than one food item may be cooked at the same time.

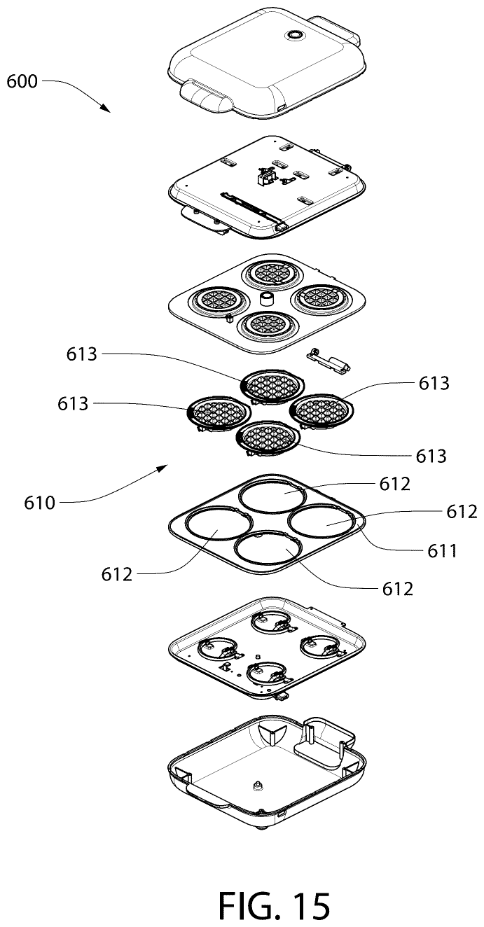

FIG. 15 is an exploded view of an alternative cooking appliance 600. The cooking appliance 600 is identical to the cooking appliance 100 described above, except for the minor differences described herein. Thus, the description above is applicable to the cooking appliance, except for the specifically noted differences. The cooking appliance 600 comprises a first plate assembly 610 that includes a support plate 611 having a plurality of openings 612 and a plurality of cooking plates 613 that are each separately detachably coupled to the support plate 611. In this embodiment, the support plate 611 has four openings 612, each configured to receive one of the cooking plates 613. Thus, the only difference between this embodiment and the one previously described is the number of openings 612 and the number of cooking plates 613 that may be coupled to the support plate 611 at one time. As noted above, in various other embodiments the support plate 611 may have other numbers of openings 612, such as one opening, two openings, three openings, four openings, five openings, six openings, seven openings, eight openings, or the like.

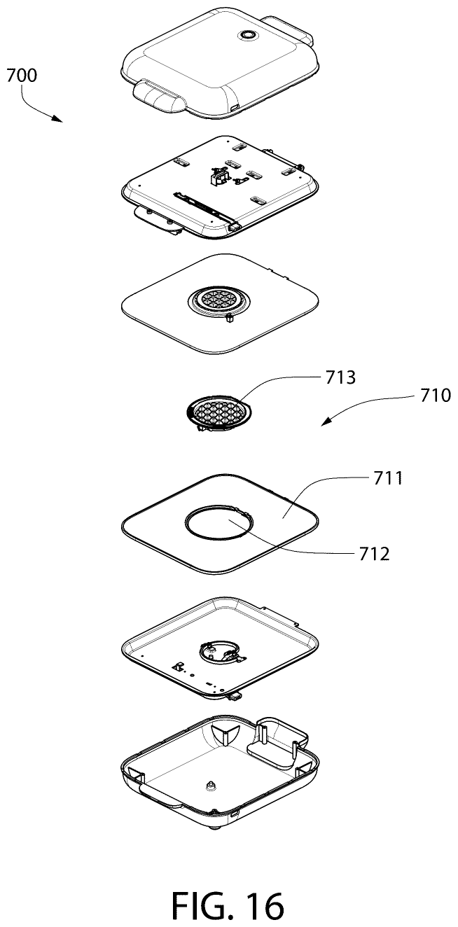

FIG. 16 is an exploded view of yet another alternative cooking appliance 700. The cooking appliance 700 is identical to the cooking appliance 100 described above, except for the minor differences described herein. Thus, the description above is applicable to the cooking appliance, except for the specifically noted differences. The cooking appliance 700 comprises a plate assembly 710 comprising a support plate 711 having a single opening 712 that is configured to detachably receive a single cooking plate 713. The cooking plate 713 may be swapped out for different cooking plates with different designs on the cooking surfaces, but the support plate 711 is only configured to be coupled to a single cooking plate 713 at a time.

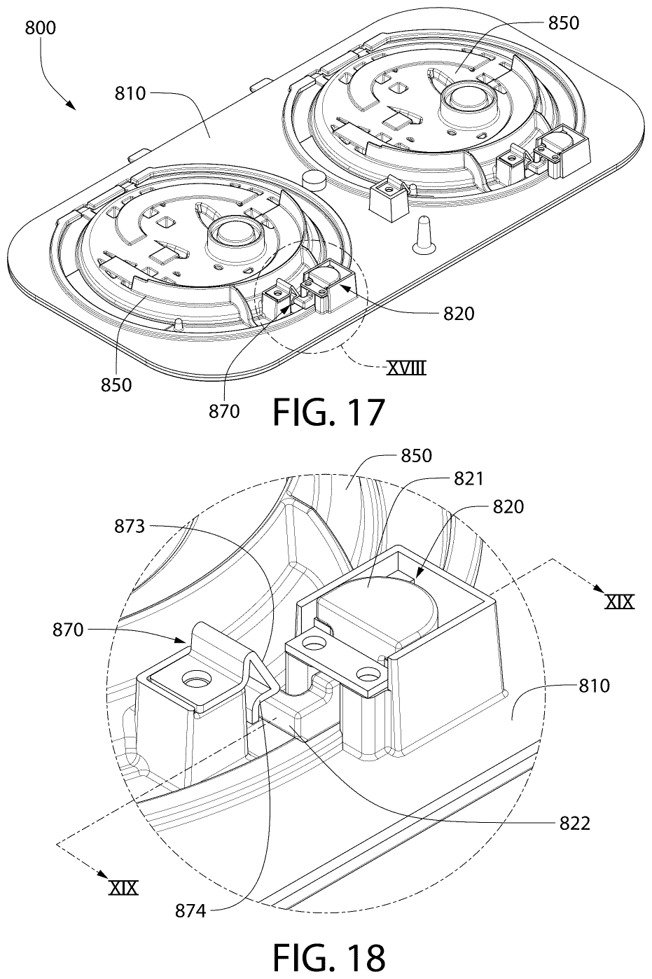

Referring to FIGS. 17-19, a plate assembly 800 is illustrated in accordance with another embodiment. The plate assembly 800 may be used in place of any of the other plate assemblies described herein, including the plate assemblies 300, 400. Furthermore, the plate assembly 800 may be used as part of any of the previously described embodiments. The plate assembly 800 is similar to the previously described plate assemblies, with the main difference being the structure and operation of the locking mechanism thereof. The plate assembly 800 generally comprises a support plate 810 and a plurality of cooking plates 850 that are detachably coupled to the support plate 810. The support plate 810 may be detachably coupled to the housing of the cooking appliance as described above with reference to the previously described embodiments.

The cooking plates 850, of which there are two in this embodiment but there could be just one or more than two in other embodiments, may be identical to the cooking plates 350, 450 of the previously described embodiments. The cooking plates 850 may comprise a cooking surface and a non-cooking surface, tabs, and other features that match the description above with reference to the cooking plates 350, 450. Furthermore, the cooking plates 850 may comprise an engagement feature 870 that is used to facilitate the attachment of the cooking plates 850 to the support plate 810 as described further herein below. The engagement feature 870 may comprise an angled engagement surface 873 and a planar locking surface 874, although other configurations for the engagement feature 870 may be used in other embodiments. The engagement feature 870 may be located on the non-cooking surface of the cooking plates 850.

The support plate 810 may comprise a locking mechanism 820 that is configured to interact with the engagement feature 870 of the cooking plate 850 to lock the cooking plate 850 to the support plate 810 in a detachable manner. The support plate 810 may comprise a distinct locking mechanism 820 for each of the cooking plates 850 configured to be coupled thereto. In the exemplified embodiment, the support plate 810 comprises two openings, each of the two openings being configured to receive one of the two cooking plates 850. The support plate 810 comprises one locking mechanism 820 associated with each of the openings, so the number of locking mechanisms 820 may match or equal the number of the openings.

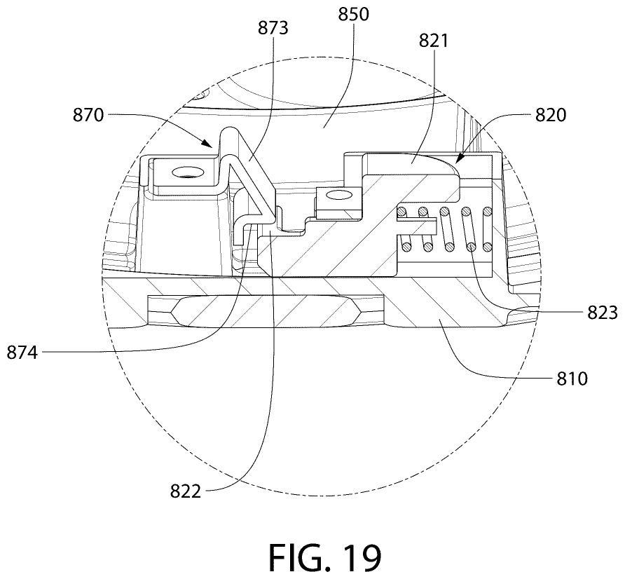

The locking mechanism 820 (or each of the locking mechanisms 820) may comprise an actuator 821 and a latch 822. The locking mechanism 820 may further comprise a spring 823 that biases the locking mechanism 820 into the locked state, which is depicted in FIGS. 18 and 19. When the locking mechanism 820 is in the locked state, the latch 822 of the locking mechanism 820 is located immediately below the planar locking surface 874 of the engagement feature 870 of the cooking plate 850 to prevent the cooking plate 850 from being detached from the support plate 810 via the opening. That is, the latch 822 blocks the cooking plate 850 from being able to be removed through the opening in the support plate 810. In order to detach the cooking plate 850 from the support plate 810, the latch 822 must first be moved out of the way.

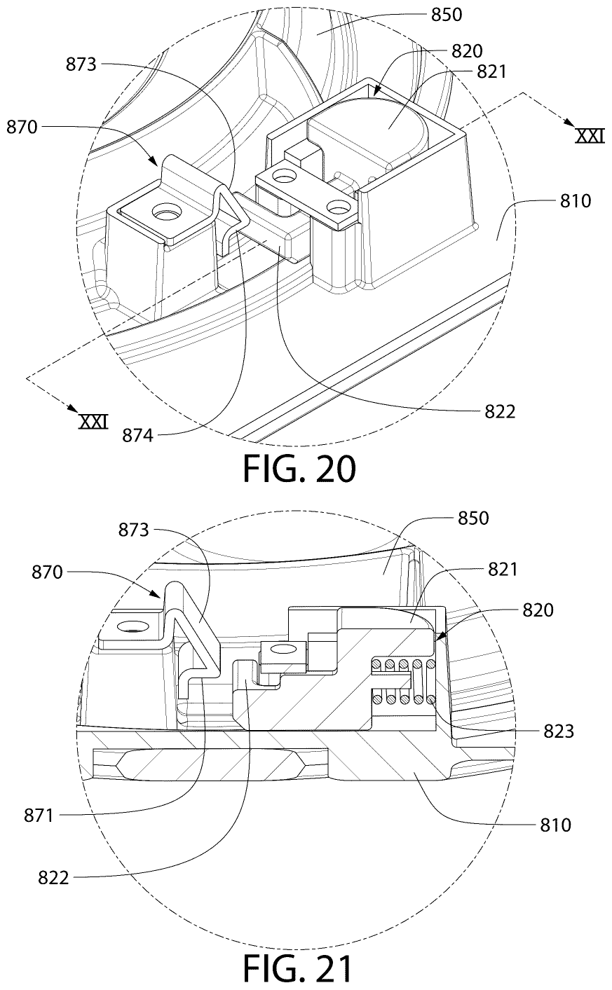

Referring to FIGS. 20 and 21, the locking mechanism 820 is illustrated in the unlocked state. To alter the locking mechanism 820 from the locked state to the unlocked state, a user may grip the actuator 821 and move the actuator 821 in a direction away from the engagement feature 870 of the cooking plate 850 against the spring force of the spring 823. Upon release of the actuator 821, the actuator 821 and the latch 822 will be forced back into the locked state due to the spring 823. Thus, in some embodiments the locking mechanism 820 may only be maintained in the unlocked state while the user physically holds the actuator 821 into the position shown in FIGS. 20 and 21. Upon the user releasing the actuator 821, the spring 823 may automatically bias the actuator 821 and the latch 822 back to the locked state/position shown in FIGS. 18 and 19. When the actuator 821 is altered into the unlocked state, the latch 822 is retracted so that it is no longer positioned below the planar locking surface 874 of the engagement feature 870 of the cooking plate 870. As such, the cooking plate 870 may be readily removed from the opening of the support plate 810 in the manner as has been described previously with reference to the earlier described embodiments.

Thus, FIGS. 17-21 illustrate an alternative locking mechanism 820 to the locking mechanism 380 described above. The locking mechanism 820 achieves the same function of locking the cooking plates to the support plate and being configured to be altered into an unlocked state, but the locking mechanism 820 has a different structure than the locking mechanism 380. Moreover, whereas the locking mechanism 380 works by rotating the latch 382 from the locked position (FIG. 13B) to the unlocked position (FIG. 13D), the locking mechanism 820 works by translating the latch 822 from the locked position (FIG. 19) to the unlocked position (FIG. 822). Further alternative structures to achieve this function of locking the cooking plates to the support plate in a detachable manner may be used in other embodiments.

As used herein in the context of the locking mechanism 820 and the engagement feature 870, the term engagement may not require a physical contact between the latch 822 and the planar locking surface 874. Rather, the term engagement may include other physical relationships between the latch 822 and the planar locking surface 874 whereby the latch 822 prevents the cooking plate from being detached from the support plate due to an interference created by the latch 822. Thus, the term engagement may include direct physical contact, abutting contact, or a blocking or interference without physical contact. In embodiments, the latch 822 may be configured to interfere with the ability of the cooking plate 850 to be detached from the support plate 810 when the locking mechanism 820 is in the locked state, with the interference being removed when the locking mechanism 820 is altered into the unlocked state.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A cooking appliance comprising:
a housing comprising a base portion defining a base cavity and a cover portion that is alterable relative to the base portion between an open state and a closed state;
a first heating element located within the base cavity of the base portion of the housing;
a plate assembly detachably coupled to the base portion of the housing to close an open top end of the base cavity, the plate assembly comprising:
a support plate comprising a top surface, a bottom surface, and at least one opening extending from the top surface to the bottom surface; and
at least one cooking plate detachably coupled to the support plate within the at least one opening of the support plate; and
wherein the support plate of the plate assembly is detachably coupled to the base portion of the housing.

2. The cooking appliance according to claim 1 further comprising:
a first locking mechanism coupled to the base portion of the housing, the first locking mechanism comprising a first button and a first latch, the first latch being movable between a locked position and an unlocked position by actuation of the first button; and
the support plate comprising a first engagement feature that is engaged by the first latch when the support plate is coupled to the base portion of the housing and the first latch is in the locked position to prevent detachment of the support plate from base portion without first altering the first latch from the locked position to the unlocked position.

3. The cooking appliance according to claim 2 further comprising:
the base portion of the housing comprising a shell defining a shell cavity and an insert that is disposed within the shell cavity, the insert comprising the base cavity and an aperture that extends from a floor of the base cavity to a rear surface of the insert;
the first locking mechanism comprising the first button that is located along an exterior of the housing and a first locking arm that is coupled to the first button and the first latch, the first locking arm extending along the rear surface of the insert and the first latch extending through the aperture of the insert and protruding from the floor of the base cavity for engagement with the first engagement feature of the support plate, the first latch being movable within the aperture when being altered between the locked and unlocked positions.

4. The cooking appliance according to claim 3 wherein the first engagement feature comprises an angled engagement surface and a planar locking surface that faces the bottom surface of the support plate, and wherein during coupling of the support plate to the base portion of the housing, the angled engagement surface engages the first latch and moves the first latch from the locked position towards the unlocked position, and wherein upon the first latch passing by the angled engagement surface, the first latch biases back into the locked position whereby the first latch engages the planar locking surface of the first engagement feature, thereby locking the support plate to the housing.

5. The cooking appliance according to claim 1 wherein the support plate comprises a peripheral edge, and wherein the at least one opening in the support plate is set inwardly relative to the peripheral edge of the support plate so that portions of the top and bottom surfaces of the support plate completely surround the at least one opening.

6. The cooking appliance according to claim 1 wherein the at least one opening comprises a first opening and a second opening that are distinct through-holes formed through the support plate, and wherein the at least one cooking plate comprises a first cooking plate that is detachably coupled to the support plate within the first opening and a second cooking plate that is detachably coupled to the support plate within the second opening.

7. The cooking appliance according to claim 1 further comprising:
for each of the at least one opening in the support plate, the support plate comprising a second locking mechanism located on the bottom surface of the support plate, each of the second locking mechanisms comprising a second actuator and a second latch that is alterable between a locked state and an unlocked state by actuation of the second actuator; and
the at least one cooking plate comprising a second engagement feature that is engaged by the second latch when the at least one cooking plate is located within the at least one opening of the support plate and the second latch is in the locked state to lock the at least one cooking plate to the support plate.

8. The cooking appliance according to claim 7 wherein the at least one cooking plate comprises a front surface and a rear surface, the second engagement feature comprising a second locking surface that is spaced apart from the rear surface of the at least one cooking plate by a gap, and wherein the second latch is located within the gap when the at least one cooking plate is located within the at least one opening of the support plate and the second latch is in the locked state to prevent detachment of the at least one cooking plate from the support plate.

9. The cooking appliance according to claim 7 wherein the second latch is biased into the locked state, and wherein inserting one of the at least one cooking plates into one of the at least one openings causes the second latch to alter from the locked state towards the unlocked state to fully seat the one of the at least one cooking plates within the one of the at least one openings, upon which the second latch automatically biases back to the locked state to lock the one of the at least one cooking plates to the support plate.

10. The cooking appliance according to claim 9 wherein the second engagement feature of the at least one cooking plate comprises a planar locking surface and an angled engagement surface, and wherein during insertion of the one of the at least one cooking plates into the one of the at least one openings, the angled engagement surface of the second engagement feature engages the second latch and moves the second latch from the locked state towards the unlocked state, and wherein upon the second latch passing by the angled engagement surface, the second latch biases back into the locked state whereby the second latch engages the planar locking surface of the second engagement feature.

11. The cooking appliance according to claim 7 further comprising:
the at least one cooking plate comprising:
a cooking surface and a non-cooking surface;
a post protruding from the non-cooking surface; and
an engagement bracket coupled to a distal end of the post, the engagement bracket comprising the second engagement feature that is configured to be engaged by the second latch to lock the at least one cooking plate to the support plate.

12. The cooking appliance according to claim 7 wherein the second latch is alterable between the locked state and the unlocked state by rotating the second actuator and the second latch or by translating the second actuator and the second latch.

13. The cooking appliance according to claim 7 wherein the second locking mechanism comprises a base plate having a top surface, a bottom surface, and an edge, wherein the second latch comprises an arm protruding from the edge of the base plate, and wherein the second actuator comprises a tab protruding from the top surface of the base plate.

14. The cooking appliance according to claim 1 wherein the at least one opening comprises at least two openings and wherein the at least one cooking plate comprises at least two cooking plates, and wherein each of the at least two cooking plates is configured to be interchangeably coupled to the support plate within either one of the at least two openings.

15. The cooking appliance according to claim 1 further comprising:
the support plate comprising a ledge having a ledge surface that is recessed relative to the top surface of the support plate; and
the at least one cooking plate comprising an annular edge portion that rests atop of the ledge surface when the at least one cooking plate is located within the at least one opening of the support plate.

16. The cooking appliance according to claim 1 further comprising:
the cover portion comprising a cover cavity, a second heating element located within the cover cavity of the cover portion of the housing;
a second plate assembly detachably coupled to the cover portion to close the cover cavity, the second plate assembly comprising:
a second support plate comprising at least one opening; and
at least one second cooking plate detachably coupled to the second support plate within the at least one opening; and
wherein the second support plate of the second plate assembly is detachably coupled to the cover portion of the housing.

17. The cooking appliance according to claim 1 wherein the cover portion of the housing is hingedly coupled to the base portion of the housing, and wherein when the cover portion is in the closed state a second cooking plate that is coupled to the cover portion and one of the at least one cooking plates of the plate assembly that is detachably coupled to the base portion form a cooking cavity for cooking a food product when the first heating element is activated to generate heat.

18. A cooking appliance comprising:
a housing comprising a first locking mechanism;
at least one heating element located within the housing;
a plate assembly comprising:
a support plate comprising a top surface, a bottom surface, at least one opening extending from the top surface to the bottom surface, a first engagement feature, and a second locking mechanism; and
at least one cooking plate comprising a second engagement feature; and
wherein the support plate is configured to be locked to the housing via engagement between the first locking mechanism of the housing and the first engagement feature of the support plate, the first locking mechanism being alterable into an unlocked state to allow the support plate to be detached from the housing; and
wherein the at least one cooking plate is configured to be locked to the support plate within the at least one opening via engagement between the second locking mechanism of the support plate and the second engagement feature of the at least one cooking plate, the second locking mechanism being alterable into an unlocked state to allow the at least one cooking plate to be detached from the support plate.

19. A cooking appliance kit comprising:
a housing comprising:
a base portion and a cover portion that is hingedly coupled to the base portion and alterable between an open state and a closed state, at least one of the base portion and the cover portion comprising a heating element; and
a first locking mechanism that is alterable between a first locked state and a first unlocked state;
a support plate configured to be detachably coupled to the housing, the support plate comprising:
a top surface, a bottom surface, and at least one opening extending from the top surface to the bottom surface;
a first engagement feature that is configured to be engaged by the first locking mechanism to lock the support plate to the housing; and
a second locking mechanism that is alterable between a second locked state and a second unlocked state;
a plurality of cooking plates, each of the plurality of cooking plates configured to be detachably coupled to the support plate within the at least one opening of the support plate, each of the plurality of cooking plates comprising a second engagement feature that is configured to be engaged by the second locking mechanism when the cooking plate is positioned within the at least one opening to lock the cooking plate to the support plate.

20. The cooking appliance kit according to claim 19 wherein each of the plurality of cooking plates comprises a cooking surface having a design characteristic and a non-cooking surface, and wherein the design characteristics of each of the plurality of cooking plates differ from one another.

21.-27. (canceled)
